(19) United States
(12) Patent Application Publication
(10) Pub. No.: US 2015/0290913 A1
(43) Pub. Date: Oct. 15, 2015

(54) LAMINATING PROCESS EMPLOYING GRID-LIKE ADHESIVE APPLICATION

(71) Applicant: Jowat SE, Detmold (DE)

(72) Inventor: Thomas Hohberg, Bielefeld (DE)

(21) Appl. No.: 14/684,641

(22) Filed: Apr. 13, 2015

(30) Foreign Application Priority Data
Apr. 14, 2014 (EP) 14164625.7

(51) Int. Cl. B32B 37/12; B32B 37/18; B32B 37/06; B32B 37/10; B32B 27/08; B32B 27/32; B29C 65/48; B29C 65/52; B32B 7/14; B32B 37/00; B32B 27/28

(52) U.S. Cl. CPC B32B 37/1292; B32B 37/003; B32B 37/18; B32B 37/06; B32B 37/1018; B32B 27/285; B32B 27/32; B29C 65/4815; B29C 65/52; B32B 7/14; B32B 27/08; B29K 2671/02; B29K 2655/00

(57) ABSTRACT

The present invention relates to a process for laminating components with sheets, in which an adhesive is applied to the surface of the laminating sheet and/or of the component in a grid-like manner, so that, after the sheet and the component are joined, the adhesive is arranged between the sheet and the component, and the regions between the applied adhesive form a channel system that enables the removal of the air that is present between the component and the sheet.

The invention further relates to a laminated molded part obtainable by the above-outlined process. The use of an adhesive grid provided between a component and a laminating sheet results in a reduction or prevention of air inclusions when the component is laminated with a laminating sheet.

### TECHNICAL FIELD

The present invention relates to a process for laminating components with sheets, in which an adhesive is applied to the surface of the laminating sheet and/or of the component in a grid-like manner, so that, after the sheet and the component are joined, the adhesive is arranged between the sheet and the component and the regions between the applied adhesive form a channel system that ensures the uniform removal (extraction)) of the air that is present between the component and the sheet by applying a reduced pressure.

The invention further relates to a laminated molded part obtainable by the above-outlined process. The use of an adhesive grid provided between a component and a laminating sheet ensures the reduction or prevention of air inclusions when the component is laminated with a laminating sheet.

### PRIOR ART

The lamination of components by applying reduced pressure or a vacuum, such as vacuum lamination or variants thereof, such as the in-mold graining (IMG) method, and/or by applying a pressing force is widespread in industry.

United States published application US 2012/121849 discloses a method for the manufacture of a laminated molded part from a component and a laminating film, wherein the bonding of the laminating sheet with the component is conducted by pressing the air present between the component and the sheet out through the channels by applying a pressing force. The adhesive between the component and the laminating film can be applied in an irregular pattern.

In vacuum-aided laminating methods, an air-impermeable or partially air-impermeable material (e.g., a decorative sheet) is generally laminated onto a solid component. The adhesive employed may be applied to the sheet or component as a preliminary coating.

In this process, the sheet may be heated and then applied to the component by providing a reduced pressure. The heat energy necessary for deforming the sheet can also be utilized for activating the adhesive. A critical precondition for the process is the air permeability (vacuum susceptibility) of the substrate (component) to be laminated in combination with the air-impermeability of the sheet. The latter property can also be achieved, for example, by an additional membrane.

While vacuum susceptibility usually exists with porous materials such as wood materials or open-pore composite materials, particular precautions must be taken for air-impermeable component materials (as typically produced in an injection molding method), or for partially air-permeable component materials, such as particular fiber composites. Such measures usually include the introducing of vacuum holes and the application of a lamination grain to the component, which enables the extraction of the air present between the sheet and the component. The lamination grain gives rise to grain grooves in the component, through which the air present between the component and sheet can be extracted.

The vacuum holes enable the air between the sheet and the component to escape by applying a reduced pressure or vacuum. However, this is often not sufficient to avoid small- to medium-sized air inclusions. These may form, for example, as a result of the geometry of the components, but also through the sheet laying process and the limited capacity of the vacuum holes. Therefore, it is usual in the prior art that a lamination grain which, even after the “first contact” of the sheet with the component, enables the further transport of air through the grooves of the graining to the holes be additionally applied to the component. However, the application of such a lamination grain to the component is technically complicated and cost-intensive, all the more so since a sufficient grain typically requires a depth of 0.2 to 0.3 mm, thus resulting in a correspondingly higher amount of material being employed and an increase in the total weight of the component. Ultimately, this may constitute up to 10% of the weight of the component.

In the automobile field, and in particular in respect of components of the interior trim of vehicles, two different processes are typically employed in practice for sheet lamination.

In a first process, the adhesive is applied by spraying onto the component. In this case, a paint-like adhesive must be avoided because this could result in the vacuum holes being clogged by the adhesive (e.g., when a dispersion or solvent adhesive is used).

In an alternative method, the adhesive (e.g., a hot-melt adhesive) is applied to the sheet. In this case, the hot-melt adhesive is heated together with the sheet to the necessary deformation temperature typical of such sheets (from 120 to 210° C., depending on the sheet), and thus activated.

In the latter process, the adhesive (usually a reactive or thermoplastic hot-melt adhesive) is a viscous fluid. This is still true during the vacuum joining process. Due to its fluidity, the viscous adhesive can very easily clog the vacuum holes of the grain grooves. This prevents the uniform extraction of air and can thus facilitate the formation of air inclusions. This leads to visible and also invisible flaws in the finished laminated molded part.

In fact, the skilled person knows that such flaws formed by air inclusions frequently occur when hot-melt adhesives are used, and the requirements in terms of grain quality and depth and the number of holes are higher than those for the first mentioned process, in which the adhesive is sprayed onto the component.

Thus, it was the object of the present invention to provide a laminating process for components in which the formation of air inclusions or flaws is substantially, and preferably completely, prevented.

In addition, the process according to the invention should also be suitable for components not possessing elaborate gravures/grains to thus enable, inter alia, a more cost-effective process (e.g., through the use of injection molds without grain structure, less wear of the injection mold), lower component weights, simpler correction of components (no need to consider the grain), and the use of materials that are either not or only poorly engraveable, such as fiber composites. The process should further enable a reduction of the number of vacuum holes in the component, and avoid incomplete cross-linking when reactive adhesives are used, which occurs when the moisture-reactive adhesive has insufficient contact with air and, thus, with moisture.

### SUMMARY OF THE INVENTION

As employed herein, the term “comprising” is to be understood to also cover the alternative in which the product/method/use in respect of which the term “comprising” is used may also “consist exclusively of” the subsequently-described elements.

Unless otherwise indicated, all percent values, ppm values and parts values described are done so are on a weight basis based on the total weight of the entire composition.

Since all numbers, values and/or expressions specifying quantities of materials, ingredients, reaction conditions, molecular weights, number of carbon atoms, and the like, used herein and in the claims appended hereto, are subject to the various uncertainties of measurement encountered in obtaining such values, unless otherwise indicated, all are to be understood as modified in all instances by the term “about.”

The process, polymers and compositions of the present invention may suitably consist (only) of, or consist essentially of the process delineations, components and elements described herein. The invention illustratively disclosed herein suitably may be practiced in the absence of any element which is not specifically disclosed herein or disclosed herein as being essential.

Where a numerical range is disclosed herein, such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10. It is to be understood that the upper and lower amount, range, and ratio limits set forth herein may be independently combined. Similarly, the ranges and amounts for each element of the invention can be used together with ranges or amounts for any of the other elements.

It has surprisingly been found that the disadvantages of the prior art are overcome by the present invention. In particular, the present invention relates to the following items:

1. A process for preparing a laminated molded part from a component (alternatively referred to as a substrate) and a laminating sheet (alternatively referred to as a sheet), characterized by comprising the following steps:
applying an adhesive in a grid-like manner to the surface of the laminating sheet and/or of the component, wherein channels are formed on the surface from the grid-like application of the adhesive;
joining the component and the laminating sheet in such a way that the layer of the adhesive applied in a grid-like manner is arranged between the laminating sheet and the component; and
bonding the laminating sheet with the component by extracting the air present between the component and the sheet through the channels by applying a reduced pressure.

2. The process according to item 1, characterized in that at least one vacuum hole through which the reduced pressure is applied is provided in said component.

3. The process according to either of items 1 or 2, characterized in that the adhesive is applied in dots or stripes, preferably in the form of truncated-pyramid-shaped, polygonal, diamond-shaped, rectangular, oval, L-shaped, round or irregularly-shaped adhesive deposits, more preferably in the form of truncated-pyramid-shaped adhesive deposits.

4. The process according to one or more of items 1 to 4, characterized in that the channels between the regions/sites of adhesive deposits remain free of adhesive during the grid-like application.

5. The process according to one or more of items 1 to 4, characterized in that said channels are maintained until the end of the laminating process.

6. The process according to one or more of items 1 to 5, characterized in that said adhesive is applied in an irregular pattern or in regions of irregular patterns.

7. The process according to one or more of items 1 to 6, characterized in that said adhesive deposits are provided at intervals of from 0.1 mm or more to 10.0 mm or less, preferably from 0.3 mm or more to 5.0 mm or less, more preferably from 0.5 mm or more to 4.0 mm or less, even more preferably 1.0 mm or more to 3.5 mm or less, especially from 1.5 mm or more to 2.5 mm or less.

8. The process according to one or more of items 1 to 7, characterized in that said adhesive is selected from the group consisting of reactive or non-reactive thermoplastic hot-melt adhesives, preferably a hot-melt adhesive based on ethylene vinyl acetates, polyacrylates, copolyamides, copolyesters, copolyethers, polyolefins, polyurethanes, or corresponding co- and/or terpolymers.

9. The process according to one or more of items 1 to 8, characterized in that said adhesive is a latent reactive two or more component system in which the reaction components are applied as a homogeneous mixture or as grid points adjacent to or over one another.

10. The process according to one or more of items 1 to 9, characterized in that said laminating sheet is a plastic sheet, preferably a plastic sheet based on polyvinyl chloride (PVC), polyolefins, thermoplastic polyolefins (TPO), polycarbonate, polyether, polyesters, polyurethanes, poly(meth)acrylate, or combinations, co- or terpolymers thereof.

11. The process according to one or more of items 1 to 10, characterized in that said laminating sheet has a thickness within a range of from 0.1 mm or more to 7.0 mm or less, preferably from 1.0 mm or more to 3.5 mm or less, more preferably from 1.5 mm or more to 2.5 mm or less.

12. The process according to one or more of items 1 to 11, characterized in that said component is made of an air-impermeable or partially air-permeable material.

13. The process according to one or more of items 1 to 12, characterized in that said component is dimensionally stable.

14. The process according to one or more of items 1 to 13, characterized in that said component is made of a material selected from the group consisting of injection-molded plastics of acrylonitrile-butadiene-styrene (ABS), polycarbonate ABS (PCABS), polypropylene (PP), polycarbonate (PC), thermoplastic polyolefin (TPO), fiber composites including natural fiber PP, glass fibers, carbon fibers, plastic fibers, mineral fillers, binder PP, polyurethane, phenolic resin, or combinations thereof.

15. The process according to one or more of items 1 to 14, characterized in that said component has no lamination grain.

16. The process according to one or more of items 1 to 15, characterized in that the laminating sheet coated with adhesive is heated before and/or during the bonding with the component.

17. The process according to one or more of items 1 to 16, characterized in that said laminated molded part is a vehicle interior trim component, or part of a vehicle interior trim component.

18. The process according to one or more of items 1 to 17, characterized in that the bonding of the laminating sheet with the component is conducted by extracting the air present between the component and the sheet through the channels by applying a reduced pressure in combination with pressing the air present between the component and the sheet out through the channels by applying a pressing force.

19. A laminated molded part, especially a vehicle interior trim component or part of a vehicle interior trim component, produced by a process according to one or more of the preceding items.

According to the invention an adhesive grid provided between a component and a laminating sheet is used for reducing or avoiding air inclusions when the component is laminated with said laminating sheet.

The lamination may include vacuum lamination, an in-mold graining (IMG) method, or mixed forms of one of them with press lamination.

The laminated molded part which are made according to the method of the invention may be used as a vehicle interior trim component, or part of a vehicle interior trim component.

### BRIEF DESCRIPTION OF THE FIGURES

FIG. 1 shows the drop structure of the adhesive application that is still present after heating and cooling.

FIG. 2 shows an example of the adhesive structure after detaching the sheet from the component.

### DETAILED DESCRIPTION OF THE INVENTION

The present invention relates to the above-described process for preparing a laminated molded part from a component and a laminating sheet and a laminated molded part, especially a vehicle interior trim component, or part of a vehicle interior trim component, obtainable by the process according to the invention.

In addition, the present invention also relates to the use of an adhesive grid provided between a component and a laminating sheet for reducing or avoiding air inclusions upon lamination of the component with the laminating sheet.

The lamination preferably includes vacuum lamination, an in-mold graining (IMG) method, press lamination, or mixed forms thereof.

In the present disclosure, a “grid-like adhesive application” according to the present invention means a structured application of adhesive on a surface (i.e., the application of an adhesive in a certain pattern having a three-dimensional structure), said structured application having channels or a channel system between the individual adhesive deposits, this system being preferably contiguous. The adhesive is preferably applied in the form of dots and/or stripes at predetermined intervals (i.e., in a particular grid). The channels (or channel system) formed thereby between the adhesive deposits enable optimum extraction, i.e., removal, of the air present between the sheet and component after the laminating sheet and the component have been joined together. The extraction of the air is typically effected through the periphery of the component, and/or by applying a reduced pressure/vacuum through vacuum holes provided in the component. In particular, the continuous channels (channel system) enable a uniform removal of the air by vacuum removal over the entire surface of the component covered with the sheet, whereby this occurs substantially independently of the geometry of the component (for example, for any given radii or peripheral edges). In sheet lamination with the additional application of pressure, i.e., the extraction of air present between the component and the sheet through the channels by applying a reduced pressure in combination with pressing the air present between the component and the sheet out through the channels by applying a pressing force, the grid-like application of adhesive which gives rise to the channel system is also advantageous because the air that is present between the component and the sheet can be removed uniformly over the entire surface of the component.

Further, it has surprisingly been found that the grid-like channel-forming structure of the adhesive application is sufficiently maintained during the laminating process, and that no flowing of the adhesive occurs. The type of adhesive employed is not limited, and thus all laminating adhesives usual in sheet laminating can, in principle, be employed. In this respect, reference is made to the relevant known prior art.

Further, the grid-like adhesive application enables sufficient contact to the surrounding air and thus to atmospheric humidity through the channels when moisture-reactive adhesives are used. This avoids incomplete cross-linking of the adhesive and thus the formation of flaws with no adhesion.

The grid-like application of adhesives, especially of hot-melt adhesives, is per se known to the skilled person. However, the grid-like application is typically employed only for reasons of reducing the adhesive quantity, better anchoring of the adhesive in open substrates such as foams, and producing breathable laminates in, for example, the lamination of breathable membranes in which a closed adhesive film is undesirable. However, its purposeful use in a laminating process using reduced pressure or the simultaneous application of reduced pressure and pressing force, in particular for reducing and avoiding air inclusions, is not known.

When a particular patterning method in which the adhesive is applied in a grid-like manner is purposefully used, regions, especially linear regions, free of (or with a clearly lower amount of) applied adhesive (so-called channels) are formed. These channels are maintained sufficiently long during the lamination process, such that a complete and extensive, i.e., uniform, removal of the air present between the sheet and the substrate via the application of suction (reduced pressure) or the simultaneous application of suction and pressing out of the air becomes possible. Preferably, the channels are maintained until the end of the lamination process and, in particular, are maintained in the ready-laminated molded part.

In principle, the geometry of the pattern or of the grid is not limited as long as it is ensured that sufficient channels are formed to enable the removal of air by suction or suction and pressing out, and to ensure sufficient access of air (and thus access of moisture to the adhesive) for moisture-reactive adhesives.

Preferably, the adhesive is applied in dots or stripes, more preferably in the form of truncated-pyramid-shaped, polygonal (for example, triangular, tetragonal, pentagonal, hexagonal, heptagonal, octagonal, nonagonal or decagonal), diamond-shaped, rectangular, oval, L-shaped, round or irregularly shaped adhesive deposits, especially in the form of truncated-pyramid-shaped adhesive deposits.

Further, patterns that are sufficiently known to the skilled person from the standard grain patterns of the components may also be employed.

The adhesive deposits (especially the truncated-pyramid-shaped adhesive deposits) are preferably applied at intervals (measured on the substrate surface) of from 0.1 mm or more to 10.0 mm or less, preferably from 0.3 mm or more to 5.0 mm or less, more preferably from 0.5 mm or more to 4.0 mm or less, even more preferably from 1.0 mm or more to 3.5 mm or less, especially from 1.5 mm or more to 2.5 mm or less.

The depth of the pattern, i.e., the thickness (height as measured from the respective substrate surface) of the adhesive deposits, is preferably within a range of from 0.1 mm or more and 1.5 mm or less, more preferably from 0.2 mm or more and 1.0 mm or less, even more preferably from 0.5 mm or more and 0.8 mm or less.

The adhesive deposits are preferably applied in an irregular arrangement or in distinct areas of differing, preferably irregular, arrangements, i.e., without forming extended linear channels. The formation of a secondary structure (i.e., a structure that becomes recognizable only by a particular regular arrangement of the adhesive deposits) is thus avoided, which has the effect that the viewer of the finished laminated component obtains the impression of a particularly smooth surface. Of course, regular adhesive deposits in the shape of geometric patterns, combinations thereof, or combinations thereof with irregular adhesive deposits are also possible. Also, the pattern of the adhesive can be adapted to the molded part, the shape of the molded part and/or the surface of the molded part.

In particular, due to the channels designed/formed by the adhesive grid, components possessing no grain (or those having a flat, typically unsuitable grain, or a smooth surface) and components having only a few (vacuum-) holes can also be laminated. Thus, a significantly lower number of flaws arises. In the preferred ideal case, the final product has no recognizable flaws.

If the adhesive is molten (e.g., when hot-melt adhesives are used), it does not flow over the entire surface. However, if a suitable pattern exists, individual droplets are formed, and the channels between the droplets are maintained. Such channels then enable a continuous transport of air in the region between the component and the laminating sheet and, in turn, the desired horizontal vacuum mobility (horizontal transport of air, i.e., removal of the air) within the adhesive grid.

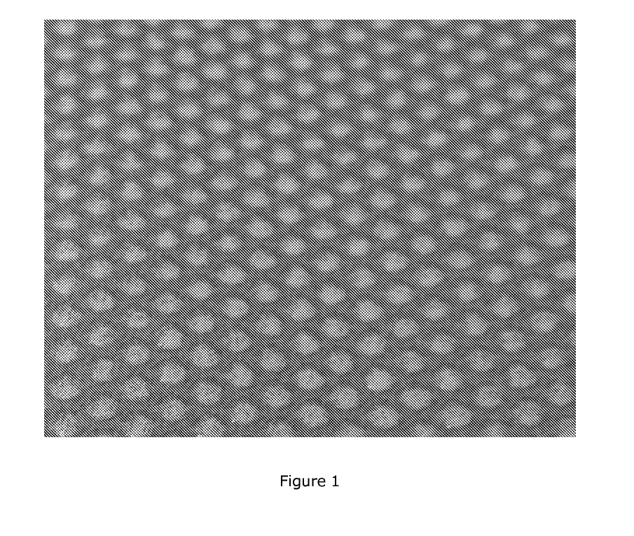

FIG. 1 shows the drop structure of the adhesive deposit between the sheet and the component that is still present after heating and cooling.

In a preferred embodiment, the adhesive is selected from the group consisting of reactive or non-reactive thermoplastic hot-melt adhesives. In a preferred embodiment the adhesive is selected from the group consisting of hot-melt adhesives based on ethylene vinyl acetates, polyacrylates, copolyamides, copolyesters, copolyethers, polyolefins, polyurethanes, and corresponding co- and/or terpolymers.

The process according to the invention is generally performed in a way wherein the joining of the laminating sheet and component is performed by applying a reduced pressure (or vacuum) or by means of the simultaneous application of a reduced pressure and a pressing force after the application of adhesive to the laminating sheet and/or component. The bonding by means of pressure (i.e., the application of a pressing force) is effected, for example, by pressing the sheet onto the component or pressing the component into the sheet whereby the sheet is placed in a rigid or elastic support whose shape is adapted to that of the component.

The application of adhesive is preferably effected on a surface of the laminating sheet that will be facing the substrate to be laminated in the subsequent step. The laminating sheet coated with adhesive in a grid-like manner can be immediately placed onto the component and subsequently laminated or, alternatively, it may be stored and used later for lamination. In the latter case, the sheet pre-coated with adhesive is preferably stable when stored. This also means that, when in the form of rolled goods, it will not block during storage and transport, and that the properties of the pattern are maintained during storage and transport.

The bonding by means of vacuum is usually effected by applying a vacuum through the periphery of the component or through openings provided in the component, through which a reduced pressure can be applied (so-called vacuum holes). The number of vacuum holes is to be adapted to the size and geometry of the respective component, and to the pattern of adhesive/application of adhesive employed. Preferably, at least one vacuum hole is provided in the component. In further embodiments according to the invention, two, three, four or even more openings are provided in the component (substrate or base part).

Preferably, the bonding of the laminating sheet and component is effected with heating, especially above the melting or softening range of the adhesive.

According to a particularly preferred embodiment, a suitable hot-melt adhesive is first applied to the laminating sheet in a grid-like manner, and the sheet is subsequently joined with the component to be laminated. The hot-melt adhesive is usually heated above its melting or softening temperature before and/or during the joining of the laminating sheet and component, such to ensure a reliable adhesive bond between the laminating sheet and the component.

In order to ensure both a reliable bond between the laminating sheet and the component and, at the same time, good processing properties such as optical properties etc., the adhesive is preferably employed or applied in an amount of from 10 g/m² or more to 200 g/m² or less, preferably from 50 g/m² or more to 100 g/m² or less.

After application, the adhesive preferably covers from 40% or more to 99% or less of the entire surface of the sheet and/or component provided with the adhesive grid, preferably of the sheet, more preferably from 60% or more to 90% or less, even more preferably from 70% or more to 85% or less.

The application of the adhesive can be effected with heating, usually with melting, at temperatures within a range of from 40° C. or more and 220° C. or less, especially from 120° C. or more and 190° C. or less.

In a preferred embodiment of the process according to the invention, this is effected through heating of the laminating sheet (the sheet being coated with the adhesive) before and/or during the bonding with the component. Alternatively, the component may also be heated.

Preferably, a solvent-free hot-melt adhesive is employed as the adhesive. In particular, these are adhesives which are solid at room temperature (21° C.+/−1° C.), anhydrous and solvent-free, which are applied in the molten state to the materials to be bonded and, after the joining, will set physically and/or chemically with solidification while cooling.

However, also suitable are pressure-sensitive adhesives, dispersion adhesives, solvent adhesives, for example, based on polyurethane, polyacrylate, ethylene/vinyl acetate (EVA), poly(vinyl acetate) (PVAC), styrene-isoprene-styrene copolymer (SIS), styrene-butadiene-styrene copolymer (SBS), or chloroprene rubber (CR).

Depending on the demands, suitable hot-melt adhesives may be, in particular, hot-melt adhesives being thermoplastic or reactive in nature.

The hot-melt adhesives employed are selected, in particular, subject to the materials to be bonded and the respective relevant requirements such as, for example, a required temperature or heat resistance of the bond, etc.

As thermoplastic hot-melt adhesives, those based on ethylene/vinyl acetates (EVA), polyolefins (e.g., amorphous poly-alpha-olefins or polyolefins produced by metallocene catalysis), polyacrylates, copolyamides, copolyesters, and/or thermoplastic polyurethanes, or corresponding co- and/or terpolymers may, in particular, be employed. Particularly preferred are polyolefins produced by metallocene catalysis, as they have an increased lack of tack.

As reactive and, for example, moisture-curing, hot-melt adhesives, those based on silane-grafted amorphous poly-alpha-olefins, silane-grafted polyolefins produced by metallocene catalysis (cf. EP 1 508 579 A1), or isocyanate-terminated polyurethanes are, in particular, employed. With reactive hot-melt adhesives, the subsequent cross-linking with moisture leads to temperature- and heat-resistant bonds. Thus, reactive hot-melt adhesives combine the advantages of an early initial strength from the physical setting process of cooling with a subsequently-occurring chemical cross-linking. When moisture-reactive hot-melt adhesives are processed, the melt must be protected from moisture before being applied.

Suitable polymers for reactive moisture-curing hot-melt adhesives according to the present invention include, for example, the silane-modified poly-alpha-olefins commercially available from Degussa AG, Marl, Germany, under the product designation “Vestoplast® 206”. Particularly preferred according to the invention are silane-modified poly-alpha-olefins with number average molecular weights, Mn, of from 5,000 to 25,000 g/mol, preferably from 10,000 to 20,000 g/mol.

As described in some detail hereinafter, additives based on non-reactive polymers, resins and/or waxes such as, for example, optionally hydrogenated rosin esters and aliphatic hydrocarbon resins, may be added to the reactive hot-melt adhesives for controlling the open time and/or the adhesive properties.

The application of the adhesive to the surface of the sheet and/or component, preferably exclusively to the surface of the sheet, is effected, as described above, in temperature ranges of from 90° C. or more to 220° C. or less, preferably from 120° C. or more to 190° C. or less.

In order to achieve a good applicability of the hot-melt adhesive, hot-melt adhesives are usually employed that have Brookfield viscosities within a range of generally from 50 to 1,000,000 mPa·s at the processing temperatures, generally from 90° C. to 200° C.

For example, according to the invention, reactive hot-melt adhesives based on silane-grafted polyolefins, especially silane-grafted poly-alpha-olefins, may be preferably employed, that have Brookfield viscosities at 180° C. within a range of from 50 to 50,000 mPa·s, especially from 1,000 to 10,000 mPa·s, preferably from 5,000 to 8,000 mPa·s, more preferably from 5,500 to 7,500 mPa·s.

For controlling the reactivity and the cross-linking behavior, catalysts suitable for such purposes per se such as, for example, dibutyltin dilaurate (DBTL), may usually be added to the reactive hot-melt adhesives in amounts common per se for such purposes. Examples of suitable catalysts according to the invention include the commonly-known catalysts in adhesives chemistry such as organic tin compounds, e.g., dibutyltin dilaurate (DBTL) as mentioned above, or alkyl mercaptide compounds of dibutyltin, or organic iron, lead, cobalt, bismuth, antimony and zinc compounds, as well as mixtures of the above-mentioned compounds, or aminebased catalysts such as tertiary amines, 1,4-diazabicyclo[2.2.2]octane and dimorpholino diethyl ether, and mixtures thereof. Particularly preferred according to the invention is dibutyltin dilaurate (DBTL), especially in combination with adhesives based on the above-mentioned reactive, preferably silane-modified, poly-alpha-olefins. The amounts of catalyst(s) employed may vary greatly; in particular, the amount of catalyst employed is from 0.01 to 5% by weight, based on the weight amount of adhesive. For controlling the application properties of the adhesives, further additives may be added, such as plasticizers, high boiling organic oils or esters or other additives serving for plasticization, stabilizers, antioxidants, acid scavengers, fillers, anti-ageing agents, and the like.

For controlling the open time and/or the adhesive properties of the above-mentioned adhesives, especially also with respect to improved handling properties, further additives based on non-reactive polymers, resins and/or waxes may be additionally added to the above-mentioned hot-melt adhesives. In this way, the adhesive properties can be adjusted or tailored according to application.

As regards the non-reactive polymers, these may be selected, for example, from the group consisting of (i) ethylene/vinyl acetate copolymers or terpolymers, especially those having vinyl acetate contents of from 12 to 40% by weight, especially from 18 to 28% by weight, and/or with melt flow indices (MFIs, DIN 53735) of from 8 to 800, especially from 150 to 500; (ii) polyolefins such as unmodified amorphous poly-alpha-olefins, especially with number average molecular weights, Mn, of from 5,000 to 25,000 g/mol, preferably from 10,000 to 20,000 g/mol, and/or with ring-and-ball softening ranges of from 80° C. to 170° C., preferably from 80° C. to 130° C., or unmodified polyolefins produced by metallocene catalysis (cf. DE 103 23 617 A1); and (iii) (meth)acrylates, such as styrene (meth)acrylates, as well as mixtures of such compounds.

The non-reactive resins may be selected, in particular, from the group consisting of hydrocarbon resins, especially aliphatic, cyclic or cycloaliphatic hydrocarbon resins, optionally modified rosins (e.g., rosin esters), terpene phenol resins, coumaroneindene resins, methylstyrene resins, polymerized liquid resin esters, and/or ketone aldehyde resins.

As the non-reactive waxes, polyolefin waxes such as, for example, polyethylene and polypropylene waxes, or waxes modified on this basis may be employed.

In a particularly preferred embodiment of the present invention, the components are interior trim components of vehicles. Such components are made, in particular, of materials based on natural-fiber-reinforced polymer materials such as, for example, a natural fiber-, for example, flax-, polypropylene material, a natural fiber-, for example, flax-, PUR, or a natural fiber-, for example, flax-, epoxy resin material, as well as a support produced by an injection molding process and made of polypropylene (PP), acrylonitrile-butadiene-styrene copolymer (ABS), styrene-isoprene-styrene copolymer (SIS), polycarbonate ABS (PCABS), polycarbonate (PC), thermoplastic polyurethane (TPU), thermoplastic polyolefin (TPO), or polyamide. These materials are widespread in automobile construction and are therefore well-known to the skilled person.

Therefore, the component is preferably made of a material selected from materials based on natural fiber-reinforced polymer materials, for example, a natural fiber-, for example, flax-, polypropylene material, a natural fiber-, for example, flax-, PUR, or a natural fiber-, for example, flax-, epoxy resin material, as well as a support produced by an injection molding process and made of polypropylene (PP), acrylonitrile-butadiene-styrene copolymer (ABS), styrene-isoprene-styrene copolymer (SIS), polycarbonate ABS (PCABS), polycarbonate (PC), thermoplastic polyurethane (TPU), thermoplastic polyolefin (TPO), or polyamide.

Particularly preferred are materials from plastic injection molding of acrylonitrile-butadiene-styrene copolymer (ABS), polycarbonate ABS (PCABS), polypropylene (PP), polycarbonate (PC), thermoplastic polyolefin (TPO), fiber composites including natural fiber PP, glass fibers, carbon fibers, plastic fibers, mineral fillers, binder PP, polyurethane, phenolic resin, or combinations thereof.

The components may be grained. However, components without a grain or with a grain unsuitable for the removal of air (which is the case, for example, when the grain is too flat) are preferred.

Further, the components are preferably dimensionally stable and/or air-impermeable, or only partially air-permeable, or vacuum-permeable.

The laminating sheet may be a plastic sheet, preferably a plastic sheet based on polyvinyl chloride (PVC), polyolefins, thermoplastic polyolefins (TPO), polycarbonate, polyether, polyesters, polyurethanes, poly(meth)acrylate, or combinations, co- and terpolymers thereof. However, also suitable are other (decorative) materials such as foam laminates, textiles, metal foils, genuine leather, artificial leather, and layer composites made from a variety of the above-mentioned materials. Air impermeability can be achieved by using additional membranes.

The laminating sheet preferably has a thickness within a range of from 0.1 mm or more and 7.0 mm or less, preferably from 1.0 mm or more and 3.5 mm or less, more preferably from 1.5 mm or more and 2.5 mm or less.

The plastic sheets include, in particular, sheets based on polyolefins such as polyethylene and polypropylene. Further, sheets based on polyester, polyamide, polycarbonate, polyvinyl chloride, poly(methyl methacrylate) and polystyrene are preferred. “Polyolefins”, such as polyethylene and polypropylene, as used herein not only means the corresponding ethylene and propylene homopolymers, but also copolymers with other olefins, such as acrylic acid or 1-olefins. Thus, “polyethylene” as used herein means, in particular, ethylene copolymers with from 0.1 to less than 50% by weight of one or more 1-olefins such as propylene, 1-butene, 1-pentene, 1-hexene, 1-octene, 1-decene, or 1-dodecene, with propylene, 1-butene and 1-hexene being preferred. “Polypropylene” also means, in particular, propylene copolymers with from 0.1 to less than 50% by weight of ethylene and/or one or more 1-olefins, such as 1-butene, 1-pentene, 1-hexene, 1-octene, 1-decene, or 1-dodecene, with ethylene, 1-butene and 1-hexene being preferred. Preferably, “polypropylene” essentially means isotactic polypropylene.

Sheets of polyethylene can be prepared from HDPE or LDPE or LLDPE.

Among sheets of polyamide, those derived from nylon 6 are preferred.

Among sheets of polyester, those made of polybutylene terephthalate and especially polyethylene terephthalate (PET) are preferred.

Among sheets of polycarbonates, those derived from polycarbonates prepared using bisphenol A are preferred.

“Sheets of polyvinyl chloride” means sheets of rigid polyvinyl chloride or soft polyvinyl chloride, wherein soft polyvinyl chloride includes copolymers of vinyl chloride with vinyl acetate and/or acrylates.

“Plastic sheets” within the meaning of the present invention may include composite sheets such as, for example, sheets comprising one of the sheets mentioned above, and a metal foil or fiber sheets.

Within the scope of the present invention, various laminating tests were performed on smooth ungrained components with a TPO foam sheet as usually employed in the automobile field, wherein different component geometries, adhesive patterns (on the TPO sheet), laminating parameters and different numbers and types of bores as well as bore positions in the component were tested. The component material and the adhesive were selected so that the adhesive builds up only limited adhesion to the components, thus enabling peeling of the laminated sheet and an exact inspection of the bonding joint. The analysis of the components laminated according to the invention showed a perfect bonding without air inclusions.

In fact, the channels formed by the pattern application are still recognizable in the laminated molded part. This avoids, for example, the incomplete or slowed cross-linking of the adhesive in regions lacking air contact (which is feared with moisture-curing reactive adhesives).

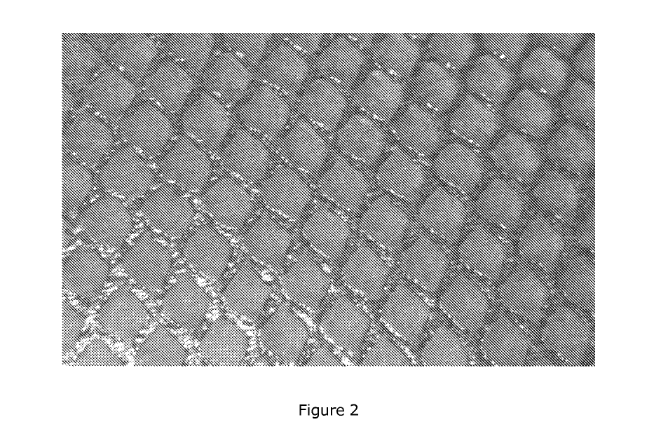

FIG. 2 shows an example of an adhesive structure after detaching the sheet from the component. The brightly shining channels, which enabled a uniform removal of the air present between the component and the sheet, are completely maintained.

By means of components with selected geometries and hole positions, it was shown that sufficient air transport within the adhesive grid is ensured over distances of more than 10 cm from the next hole, as well as over critical regions such as edges and radii.

Further, it has been found that a substantially lower number of vacuum holes is necessary as compared to those required in current practice. Elongate hole shapes (e.g., long holes) whose length exceeds that of the pattern grid have proven particularly useful. Thus, it is ensured that a hole cannot be clogged by a single adhesion deposit, and that there is always contact between the hole and the channel system in the adhesive grid.

Comparative experiments with a classical smooth (i.e., not grid-like) roller application of the same amount of adhesive do not show any horizontal air transport on ungrained surfaces. Only in regions where the sheet is practically “rolled out” onto the component because of the component geometry and the dynamics of the laminating process, can no air inclusions be seen. In particular, all surfaces show a lack of wetting and bonding caused by air inclusions over about 20 to 80% of the surface, even in the presence of a number of holes. Also comparative experiments without adhesive show practically no horizontal air transport. The soft sheet seals immediately to the smooth substrate.

### EXAMPLES

All determinations and measurements of parameters were performed, unless stated otherwise, under the standard conditions familiar to the skilled person, i.e., at room temperature (21° C.+/−1° C.) and under atmospheric pressure (1 atm).

In the following experiments, a non-reactive polyolefin-based hot-melt adhesive from Jowat AG, Germany (Jowat Toptherm® 238.30) was used.

The adhesive was applied to the bottom side of a TPO sheet (BeneckeKaliko/Germany, 2 mm foam with 0.8 mm cover layer) by means of a gravure roller from the company Hardo (Germany) by roller application.

A dish-like component (240 mm diameter, 50 mm depth) of polyoxymethylene (POM) without grain with vacuum holes at intervals of about 2 cm in the outer periphery was laminated with the coated sheet on a single position vacuum laminating system from the company Kiefel (Germany), wherein the bottom side of the sheet was heated at 180° C., the top side was heated at 140° C., and the sheet was drawn by 5% in the longitudinal and transversal directions. Subsequently, the laminated component was examined for flaws caused by air inclusions and for the size of the laminated area (to estimate the range of the transport of air through the channels of the pattern).

The results are shown in the following Table:

TABLE

| | Adhesive | | | Number | |
|---|---|---|---|---|---|
| | application | Pattern | | of | |
| | mass per | grid | Pattern | vacuum | Result of |
| No. | unit area | spacing | depth | holes | lamination |
| 1 | 70 g/m² | 2.5 | 0.64 | 35 holes | very good: no |
| | | mm | mm | (diameter | flaws, very large |
| | | | | 0.5 mm) | lamination area |
| 2 | 40 g/m² | 1.0 | 0.55 | 35 holes | good: no flaws, |
| | | mm | mm | (diameter | large lamination |
| | | | | 0.5 mm) | area |
| 3 | 70 g/m² | smooth | smooth | 35 holes | insufficient: |
| | | | | (diameter | many flaws, |
| | | | | 0.5 mm) | very small |
| | | | | | lamination area |
| 4 | 40 g/m² | smooth | smooth | 35 holes | insufficient: |
| | | | | (diameter | many flaws, |
| | | | | 0.5 mm) | very small |
| | | | | | lamination area |
| 5 | 70 g/m² | 2.5 | 0.64 | 4 holes | satisfactory: no |
| | | mm | mm | (diameter | flaws, medium- |
| | | | | 0.5 mm) | sized lamination |
| | | | | | area |
| 6 | 70 g/m² | 2.5 | 0.64 | 4 long | very good: no |
| | | mm | mm | holes | flaws, large |
| | | | | (0.5 mm × | lamination area |
| | | | | 5 mm) | |
| 7 | 70 g/m² | 2.5 | 0.64 | without | insufficient: |
| | | mm | mm | holes | lamination not |
| | | | | | possible, access |
| | | | | | to vacuum |
| | | | | | insufficient |

1. A process for preparing a laminated molded part from a component and a laminating sheet, comprising:
applying an adhesive in a grid-like manner to a surface of at least one of the laminating sheet and the component, wherein channels are formed on the surface from the grid-like application of the adhesive;
joining the component and the laminating sheet in such a way that the layer of the adhesive applied in a grid-like manner is arranged between the laminating sheet and the component; and
bonding the laminating sheet with the component by extracting air present between the component and the laminating sheet through the channels by applying a reduced pressure between the component and the laminating sheet.

2. The process according to claim 1, wherein the step of applying the adhesive includes applying the adhesive as dots or stripes in a form selected from truncated-pyramid-shaped, polygonal, diamond-shaped, rectangular, oval, L-shaped, round and irregularly-shaped adhesive deposits.

3. The process according to claim 2, wherein said adhesive deposits are provided at intervals of from about 0.1 mm to about 10.0 mm.

4. The process according to claim 1, wherein said adhesive is selected from the group consisting of reactive and non-reactive thermoplastic hot-melt adhesives, and hot-melt adhesives based on ethylene vinyl acetates, polyacrylates, copolyamides, copolyesters, copolyethers, polyolefins, polyurethanes, and corresponding copolymers and terpolymers.

5. The process according to claim 1, wherein said laminating sheet is a plastic sheet produced from a composition selected from polyvinyl chloride (PVC), polyolefins, thermoplastic polyolefins (TPO), polycarbonate, polyether, polyesters, polyurethanes, poly(meth)acrylate, copolymers and terpolymers thereof, and combinations thereof.

6. The process according to claim 1, wherein said laminating sheet has a thickness within a range of from about 0.1 mm to about 7.0 mm.

7. The process according to claim 1, wherein said component is made of an air-impermeable or partially air-permeable material.

8. The process according to claim 1, wherein said component is made of a material selected from injection-molded plastics of acrylonitrile-butadiene-styrene (ABS), polycarbonate ABS (PCABS), polypropylene (PP), polycarbonate (PC), thermoplastic polyolefin (TPO), fiber composites, natural fiber PP, glass fibers, carbon fibers, plastic fibers, mineral fillers, binder PP, polyurethane, phenolic resin, and combinations thereof.

9. The process according to claim 1, wherein said component has no lamination grain.

10. The process according to claim 1, further comprising heating the laminating sheet coated with adhesive before bonding or during bonding with the component.

11.-15. (canceled)

16. The process according to claim 10, wherein the step of bonding includes applying a reduced pressure in combination with pressing the air present between the component and the laminating sheet out through the channels by applying a pressing force.

17. The process according to claim 16, wherein the step of applying the adhesive includes applying the adhesive as dots or stripes in a form selected from truncated-pyramid-shaped, polygonal, diamond-shaped, rectangular, oval, L-shaped, round and irregularly-shaped adhesive deposits.

18. The process according to claim 11, wherein the step of applying the adhesive includes applying the adhesive as dots or stripes in a form selected from truncated-pyramid-shaped, polygonal, diamond-shaped, rectangular, oval, L-shaped, round and irregularly-shaped adhesive deposits.

19. The process according to claim 1, wherein said step of bonding includes vacuum lamination.

20. The process of claim 1, wherein the laminated molded part is a part of a vehicle interior trim component.
